(19) United States
(12) Patent Application Publication
(10) Pub. No.: US 2003/0160048 A1
(43) Pub. Date: Aug. 28, 2003

(54) Cooking vessel for use in microwave oven

(75) Inventor: Hsi-Hsun Chen, Changhua Hsien (TW)

Correspondence Address: BACON & THOMAS, PLLC, 625 SLATERS LANE, FOURTH FLOOR, ALEXANDRIA, VA, 22314

(73) Assignee: OKAY ENTERPRISE CO., LTD., Changhua Hsien (TW)

(21) Appl. No.: 10/079,553

(22) Filed: Feb. 22, 2002

(51) Int. Cl. H05B 6/80

(52) U.S. Cl. 219/732; 219/735; 219/726

(57) ABSTRACT

A cooking vessel for use in microwave oven mainly includes a food container; a cover for the food container; a supporting member attached to an upper inner wall of the microwave oven; and a mixer assembly including a vertical rod, two vertically spaced through holes provided on a lower part of the rod, and two mixing members oppositely connected to the through holes via insertion bars of the mixing members. Each of the through holes on the rod of the mixer assembly includes a sectorial upper part. A limiting rib on each insertion bar shifts to left or right side of the sectorial upper part of a corresponding one of the through holes to change an angular position of the mixing member relative to the rod and the food container when a turntable of the microwave oven rotates; enabling food in the container to be quickly and evenly mixed.

### FIELD OF THE INVENTION

The present invention relates to a cooking vessel for use in microwave oven, and more particularly to a cooking vessel having two opposite and vertically spaced mixing members, an angular position of which relative to a food container of the cooking vessel changes with rotation of a turntable of the microwave oven, enabling food in the container to be quickly and evenly mixed.

### BACKGROUND OF THE INVENTION

FIG. 1 is an exploded perspective view of a conventional cooking vessel for use in microwave oven. As shown, the cooking vessel mainly includes a container 10, a cover 20, a supporting member 30, and a mixing rod 40. The container 10 is provided along an upper outer periphery with a retaining rib 11. The cover 20 is formed at a central area with a recess 21 of predetermined dimensions. The recess 21 is provided at a bottom with a round central hole 22, and around the central hole 22 with a plurality of arcuate slots 23. A top surface of the cover 20 is also provided with a plurality of arcuate slots 24. Retaining projections 25 are equally spaced along a lower outer periphery of the cover 20 for engaging with the retaining rib 11 of the container and thereby closing the container 10 with the cover 20. The supporting member 30 has two upper ends at where two trays 31 having two magnets 32 received therein are provided, so that the supporting member 30 is magnetically attached to an upper inner wall of the microwave oven. A locating ring 33 is provided at a lower end of the supporting member 30, and an engaging projection 331 is provided on an inner wall of the locating ring 33. The mixing rod 40 is provided with a plurality of axially extended engaging grooves 41 and has a curved mixing plate 42 connected to a lower end thereof.

To use the conventional cooking vessel of FIG. 1 to cook food in a microwave oven, first upward extend the mixing rod 40 through the round hole 22 on the cover 20 and the locating ring 33 of the supporting member 30 above the cover 20. The engaging projection 331 in the locating hole 33 may be engaged with any one of the retaining grooves 41 on the mixing rod 40. Thereafter, put food to be cooked in the container 10 and close the container 10 with the cover 20 by engaging the retaining projections 25 with the retaining rib 11. Seasonings may be put in the recess 21 on the cover 20. Then, position the food-loaded and closed container 10 into the microwave oven with the magnets 32 on the supporting member 30 magnetically attached to the upper inner wall of the microwave oven. And then, turn on the microwave oven to start cooking.

The following disadvantages are found in the above-described conventional cooking vessel for use in microwave oven:

1. The curved mixing plate 42 at the lower end of the mixing rod 40 has a fixed length. When the turntable of the microwave oven turns, the mixing rod 40 mixes food in the container 10 only within a fixed area. Seasonings added into the container 10 are not evenly mixed with the food.

2. The curved mixing plate 42 at the lower end of the mixing rod 40 has a fixed length that does not enable the mixing rod 40 to evenly mix food in the container 10. As a result, an increased time is needed to cook the food.

3. Seasonings are put in the central recess 21 of the cover 20 to drop into the container 10 via the arcuate slots 23 provided at the bottom of the recess 21. The seasonings tend to aggregate into mass instead of being evenly distributed in the food.

It is therefore tried by the inventor to develop an improved cooking vessel for use in microwave oven to eliminate drawbacks existing in the conventional ones.

### SUMMARY OF THE INVENTION

A primary object of the present invention is to provide a cooking vessel for use in microwave oven. The cooking vessel includes a mixer assembly having a vertical rod and two mixing members inserted into two vertically spaced holes on the vertical rod. Each of the two holes have a sectorial upper part, allowing a limiting rib at an inner end of the mixing member to shift sideward in the sectorial upper part when the turntable of the microwave oven turns, so that the mixing members change their angular positions relative to a food container of the cooking vessel when the turntable turns clockwise and counterclockwise alternately, and thereby evenly mix the food and the seasonings in the food container.

In the above-describe cooking vessel for use in microwave oven, the two mixing members are adjustably inserted into the holes on the rod of the mixer assembly in two opposite directions to provide increased area of mixing in the food container, so that the mixing can be done more quickly and more evenly.

In the above-describe cooking vessel for use in microwave oven, the cover is provided at a top with an annular recess having a predetermined width and an outward and downward inclined inner sidewall, on which radially arranged elongated slots are provided. Seasonings may be put in the annular recess for them to evenly drop into the food container via the elongated slots. The problem of caked seasonings in the cooked food can therefore be avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is an exploded perspective view of a conventional cooking vessel for use in a microwave oven;

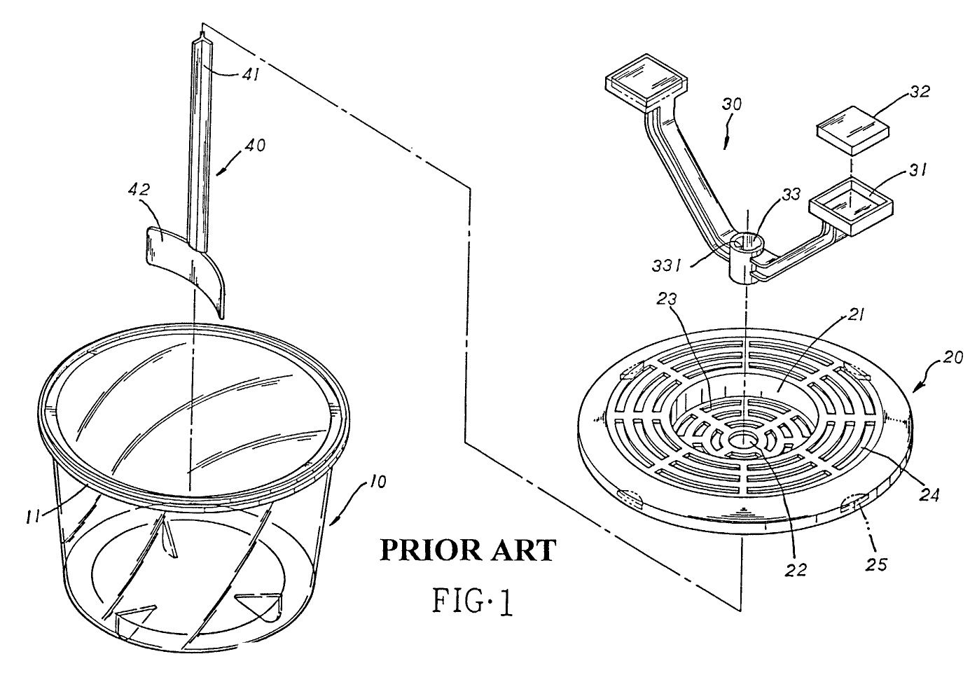

FIG. 2 is an exploded perspective view of a cooking vessel for use in a microwave oven according to the present invention;

FIG. 3 is an assembled perspective view of the cooking vessel of FIG. 2, wherein the cooking vessel turns clockwise along with a turntable in the microwave oven;

FIG. 4 is an assembled perspective view of the cooking vessel of FIG. 2, wherein the cooking vessel turns counterclockwise along with a turntable in the microwave oven; and

FIG. 5 is a fragmentary and enlarged plan view showing the manner in which a mixer assembly of the present invention operates.

### DETAILED DESCRIPTION OF THE PREFERRED EMBODIMENTS

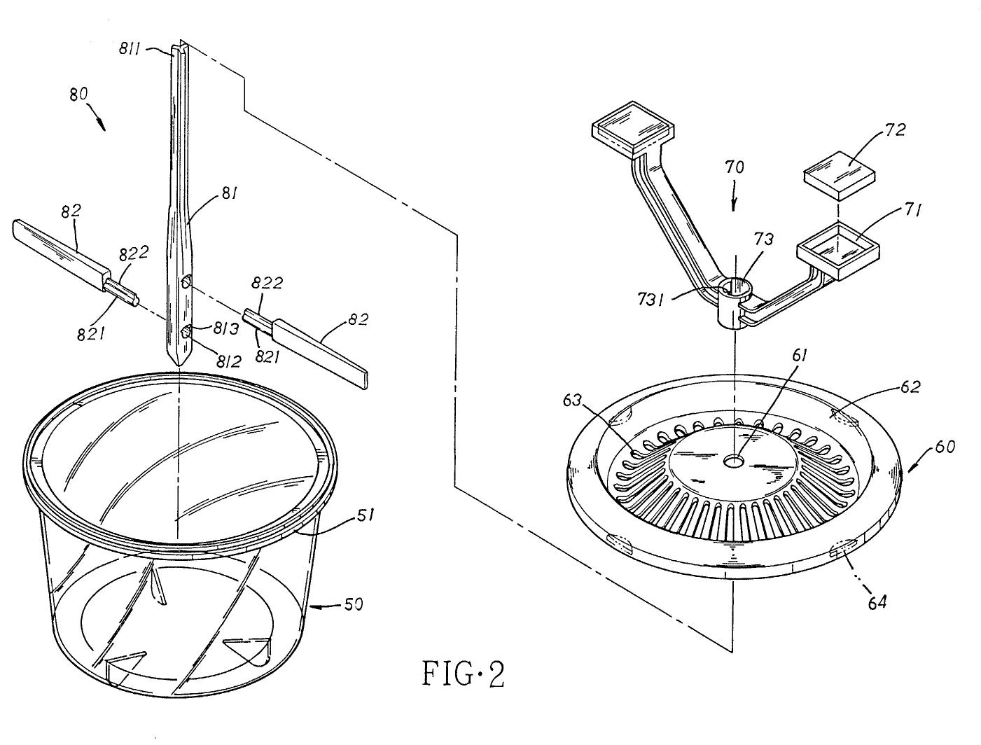

Please refer to FIG. 2 that is an exploded perspective view of a cooking vessel for use in a microwave oven according to the present invention. As shown, the cooking vessel mainly includes a food container 50, a cover 60, a supporting member 70, and a mixer assembly 80.

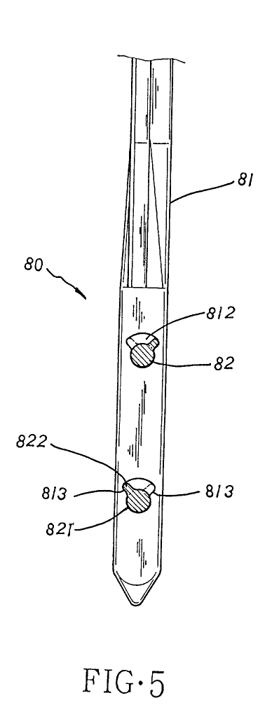

The food container 50 is provided along an outer periphery of an upper rim with a retaining rib 51. The cover 60 includes a centered round hole 61; an annular recess 62 having a predetermined width and an outward and downward inclined inner sidewall, on which a plurality of elongated slots 63 are radially arranged; and a plurality of radially inward projections 64 equally spaced along a lower outer periphery of the cover 60. The supporting member 70 has two outward and upward extended arms, upper ends of which are provided with two trays 71 for receiving two magnets 72 therein; and a central locating ring 73 formed at a joint of lower ends of the two arms. A radially inward engaging projection 731 is provided on an inner peripheral wall of the locating ring 73. The mixer assembly 80 includes a rod 81, an upper part of which has a reduced thickness and is formed of a plurality of engaging grooves 811 to axially extend from an upper end to a near middle point of the rod 81, and a lower part of the rod 81 has an increased thickness and a rectangular cross section; two vertically spaced through holes 812 provided on the rectangular lower part of the rod 81; and two mixing members 82 connected to the rod 81 via the through holes 812. Each of the through holes 812 includes a sectorial upper part with two lateral ends thereof serving as two stoppers 813, as shown in FIG. 5. The mixing members 82 of the mixer assembly 80 are two flat plates having a predetermined length and variable thickness that gradually decreases from an inner end toward an outer end of the mixing members 82. An insertion bar 821 is extended from the inner end of each mixing members 82, and an axial limiting rib 822 is provided along a full length of the insertion bar 821.

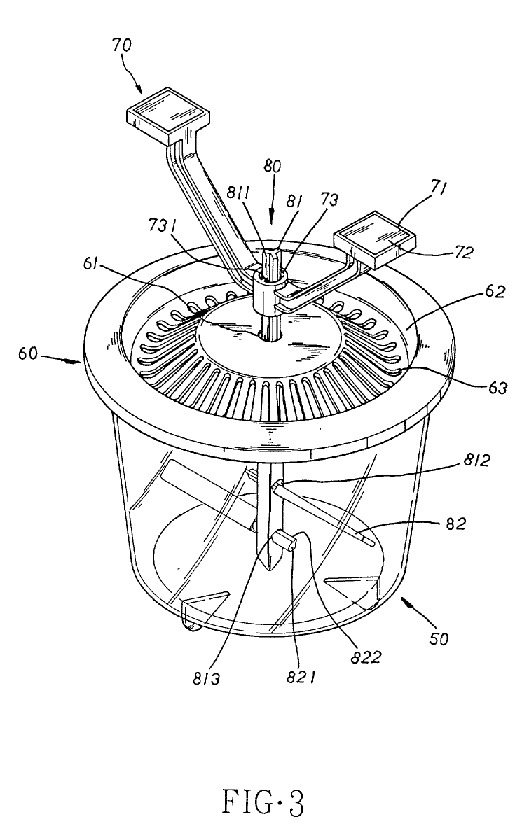

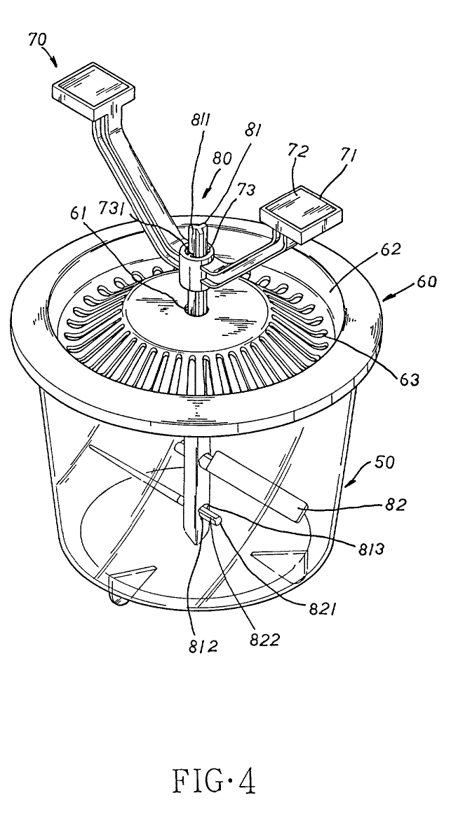

Please refer to FIGS. 3 and 4 that are assembled perspective views of the cooking vessel of the present invention turning clockwise and counterclockwise, respectively, along with a turntable in the microwave oven (not shown). To use the cooking vessel of the present invention to cook food in the microwave oven, first connect the two mixing members 82 to the rod 81 of the mixer assembly 80 by firmly extending the insertion bars 821 into the two through holes 812 from two opposite directions, so that the limiting ribs 822 on the insertion bars 82 are separately located in and limited to the sectorial upper parts of the through holes 812. Then, upward extend the upper end of the rod 81 of the mixer assembly 80 through the round hole 61 at the center of the cover 60 and the locating ring 73 of the supporting member 70 for the rod 81 to project from the locating ring 73 by a predetermined length. The engaging projection 731 in the locating ring 73 is adapted to engage with any one of the engaging grooves 811 on the rod 81. Then, put food to be cooked into the food container 50 and close the cover 60 onto a top of the food container 50 by engaging the inward projections 64 into the retaining rib 51 around the upper rim of the container 50. At this point, the two mixing members 82 are located in the food container 50 and are laterally adjustable relative to the rod 81 within a predetermined range, and the rod 81 extended through the round hole 61 and the locating ring 73 is up and down movable in the locating ring 73. Seasonings (not shown) may be put in the annular recess 62 of the cover 60 before the food container 50 is positioned into the microwave oven. Then, connect upper ends of the supporting member 70 to an inner upper wall of the microwave oven via magnetic attraction force of the magnets 72. And then turn on the microwave oven to cook the food.

When the microwave oven is turned on, the food container 50 with the cover 60 closed thereonto turns along the turntable in the microwave oven while the supporting member 70 is fixedly attached to the inner upper wall of the microwave oven and the rod 81 of the mixer assembly 80 is allowed to move up and down within the locating ring 73. When the food container 50 alternately turns clockwise and counterclockwise along with the turntable of the microwave oven, the mixing members 82 of the mixer assembly 80 are pushed by the food in the container 50 to shift the limiting ribs 822 to left or right stopper 813 of the sectorial upper part of the through holes 812. That is, the two mixing members 82 change their angular positions relative to the rod 81 and the container 50 when the turntable of the microwave oven rotates. The seasonings put in the annular recess 62 of the cover 60 evenly fall into the food container 50 via the radially arranged elongated slots 63 and are evenly mixed with the food by the mixing members 82.

The present invention has been described with a preferred embodiment thereof and it is understood that many changes and modifications in the described embodiment can be carried out without departing from the scope and the spirit of the invention as defined by the appended claims.

What is claimed is:

1. A cooking vessel for use in microwave oven, comprising a food container, a cover for removably closing a top of said food container, a supporting member, and a mixer assembly;
said food container being provided along an outer periphery of an upper rim with a retaining rib;
said cover being provided at a center with a round hole, and along a lower outer periphery with a plurality of equally spaced and radially inward projections for engaging with said retaining rib to close said cover onto said food container; said cover being provided at a top with an annular recess having a predetermined width and an outward and downward inclined inner sidewall, on which a plurality of radially arranged elongated slots are provided;
said supporting member including two upward and outward extended arms, upper ends of which being provided with two trays for receiving two magnets therein, and a locating ring formed at a joint of lower ends of said two arms; and said locating ring being provided on an inner wall with a radially inward engaging projection; and
said mixer assembly including a vertical rod, an upper part of which having a reduced thickness and being provided with a plurality of axial engaging grooves, and a lower part of which having an increased thickness and a rectangular cross section, two vertically spaced through holes provided on said rectangular lower part of said rod, and two mixing members connected to said rod via said through holes; said mixing members of said mixer assembly being two flat plates having a predetermined length and variable thickness that gradually decreases from an inner end toward an outer end of said mixing members, and an insertion bar being extended from the inner end of each said mixing member and having an axially extended limiting rib provided along a full length of said insertion bar for extending into one of said through holes on said rod; and
said two mixing members of said mixer assembly being pushed by the food in said container to shift said limiting ribs to left or right side of said through holes, so that said two mixing members change their angular positions relative to said rod and said food container when the turntable of the microwave oven rotates, and thereby quickly and evenly mix food being cooked in said food container.

2. The cooking vessel for use in microwave oven as claimed in claim 1, wherein said trays and said magnets at two upper ends of said supporting member may be otherwise replaced with sucking discs.

3. The cooking vessel for use in microwave oven as claimed in claim 1, wherein each of said through holes on said rod of said mixer assembly includes a sectorial upper part with two lateral ends thereof serving as two stoppers to limit said limiting rib on each mixing member to said sectorial upper part.
